(19) United States
(12) Patent Application Publication
(10) Pub. No.: US 2024/0126553 A1
(43) Pub. Date: Apr. 18, 2024

(54) DATA PROCESSING METHOD AND APPARATUS, AND RELATED PRODUCT

(71) Applicant: Anhui Cambricon Information Technology Co., Ltd., Hefei (CN)

(72) Inventors: Xuyan MA, Hefei (CN); Jianhua WU, Hefei (CN); Shaoli LIU, Hefei (CN); Xiangxuan GE, Hefei (CN); Hanbo LIU, Hefei (CN); Lei ZHANG, Hefei (CN)

(21) Appl. No.: 17/619,781

(22) PCT Filed: Apr. 28, 2021
(86) PCT No.: PCT/CN2021/090676

§ 371 Date: Oct. 3, 2022

(30) Foreign Application Priority Data
May 8, 2020 (CN) 202010383677.3

(51) Int. Cl. G06F 9/30

(52) U.S. Cl. CPC G06F 9/30196; G06F 9/30036

(57) ABSTRACT

A data processing method and apparatus, and a related product. The data processing method comprises: when a decoded processing instruction is a vector extension instruction, determining a source data address, a destination data address and an extension parameter of data corresponding to the processing instruction; according to the extension parameter, extending first vector data of the source data address, so as to obtain extended second vector data; storing the second vector data to the destination data address, wherein the source data address and the destination data address comprise consecutive data addresses. Vector extension and storage are implemented by means of an extension parameter in a vector extension instruction, so as to obtain extended vector data, thereby simplifying processing, and reducing data overhead.

### CROSS REFERENCE OF RELATED APPLICATION

The application claims priority to Chinese Patent Application No. 202010383677.3, filed to the China National Intellectual Property Administration on May 8, 2020 and entitled “DATA PROCESSING METHOD AND APPARATUS, AND RELATED PRODUCT”, the entire disclosure of which is hereby incorporated by reference in its entirety.

### TECHNICAL FIELD

The present disclosure relates to the technical field of computers, and more particularly to a method and apparatus for data processing and related products.

### BACKGROUND

With the development of artificial intelligence technology, the artificial intelligence technology has achieved a good effect in image recognition and other fields. During image recognition, (such as, difference calculation, extension, deformation, and the like) a large amount of vector data needs to be processed. However, in the related art, the processing is relatively complex, and data overhead is relatively high.

### SUMMARY

In view of above technical problems, it is necessary to provide a method and apparatus for data processing and related products.

A first aspect of the present disclosure provides a method for data processing. The method includes: determining a source data address, a destination data address, and an extension parameter of data corresponding to the processing instruction when a decoded processing instruction is a vector extension instruction; obtaining a second vector data extended by extending first vector data of the source data address according to the extension parameter; storing the second vector data to the destination data address, where the source data address and the destination data address include consecutive data addresses.

A second aspect of the present disclosure provides an apparatus for data processing. The apparatus includes an address determining unit, a data extending unit, and a data storing unit. The address determining unit is configured to determine, on condition that a decoded processing instruction is a vector extension instruction, a source data address, a destination data address, and an extension parameter of data corresponding to the processing instruction. The data extending unit is configured to obtain second vector data extended by extending first vector data of the source data address according to the extension parameter. The data storing unit is configured to store the second vector data to the destination data address. The source data address and the destination data address include consecutive data addresses.

A third aspect of the present disclosure provides an artificial intelligence chip. The chip includes the apparatus for data processing described above.

A fourth aspect of the present disclosure provides an electronic device. The electronic device includes the artificial intelligence chip described above.

A fifth aspect of the present disclosure provides a board card. The board card includes a storage component, an interface apparatus, a control component, and the artificial intelligence chip described above. The artificial intelligence chip is connected with the storage component, the control component, and the interface apparatus respectively. The storage component is configured to store data. The interface apparatus is configured to realize data transmission between the artificial intelligence chip and an external device. The control component is configured to monitor a state of the artificial intelligence chip.

According to embodiments of the present disclosure, vector extension and storage may be achieved according to the extension parameter in the vector extension instruction, to obtain the extended vector data, thereby simplifying processing and reducing data overhead.

Beneficial effects corresponding to the technical problems in the background may be derived according to the technical features in the claims. Additional features and aspects of the present disclosure will become apparent according to the detailed description of exemplary embodiments in following accompanying drawings.

### BRIEF DESCRIPTION OF THE DRAWINGS

The specification and the accompanying drawings included in the specification and constituting a part of the specification cooperatively illustrate exemplary embodiments, features, and aspects of the present disclosure, and are used to explain the principle of the present disclosure.

FIG. 1 is a schematic diagram of a processor for a data processing method, according to an embodiment of the present disclosure.

FIG. 2 is a flow chart of a method for data processing, according to an embodiment of the present disclosure.

FIG. 3 is a block diagram of an apparatus for data processing, according to an embodiment of the present disclosure.

FIG. 4 is a structural block diagram of a board card, according to an embodiment of the present disclosure.

### DETAILED DESCRIPTION

Technical solutions in embodiments of the present disclosure will be described clearly and completely hereinafter with reference to accompanying drawings in the embodiments of the present disclosure. Apparently, the described embodiments are some rather than all embodiments of the present disclosure. All other embodiments obtained by those of ordinary skill in the art based on the embodiments of the present disclosure without creative efforts shall fall within the protection scope of the present disclosure.

It should be understood that, the terms “include/comprise” and “contain” as well as variations thereof used in the specification and claims of the present disclosure mean existence of described features, wholes, steps, operations, elements, and/or components, but do not exclude existence or addition of one or more other features, wholes, steps, operations, elements, components, and/or sets thereof.

It should also be understood that, terms used in the specification of the present disclosure are merely for describing a specific embodiment, and not intended to limit the present disclosure. As used in the specification and claims of the present disclosure, unless the context clearly indicates otherwise, the terms “a/an”, “a piece of”, and “the/this” in a singular form, and the like may include plural forms. It should be further understood that, the term “and/or” used in the specification and claims of the present disclosure refers to any combinations of one or more of items listed in association and all possible combinations, and may include these combinations.

As used in the specification and claims, the term “if” may be interpreted as “when”, “once”, “in response to a determination”, or “in response to a case where something is detected” depending on the context. Similarly, depending on the context, the terms “if it is determined that” or “if [the condition or event described] is detected” may be interpreted as “once it is determined that”, or “in response to a determination”, or “once [the condition or event described] is detected”, or “in response to a case where [the condition or event described] is detected.

A method for data processing according to an embodiment of the present disclosure may be applied to a processor. The processor may be a general-purpose processor, such as a central processing unit (CPU), or an artificial intelligence processing unit (IPU) for executing an artificial intelligence computation. The artificial intelligence computation may include a machine learning computation, a neuromorphic computation, and the like. The machine learning computation includes a neural network computation, a k-means computation, a support vector machine computation, and the like. The IPU may, for example, include any one or any combinations of a graphics processing unit (GPU), a neural-network processing unit (NPU), a digital signal processing unit (DSP), and a field-programmable gate array (FPGA). There is no restriction on specific types of the processor in the present disclosure.

In a possible implementation, the processor involved in the present disclosure may include multiple processing units. Each processing unit may separately execute various assigned tasks, such as a convolution computation task, a pooling task, a fully connected task, and the like. There is no restriction on the processing unit and the tasks executed by the processing unit in the present disclosure.

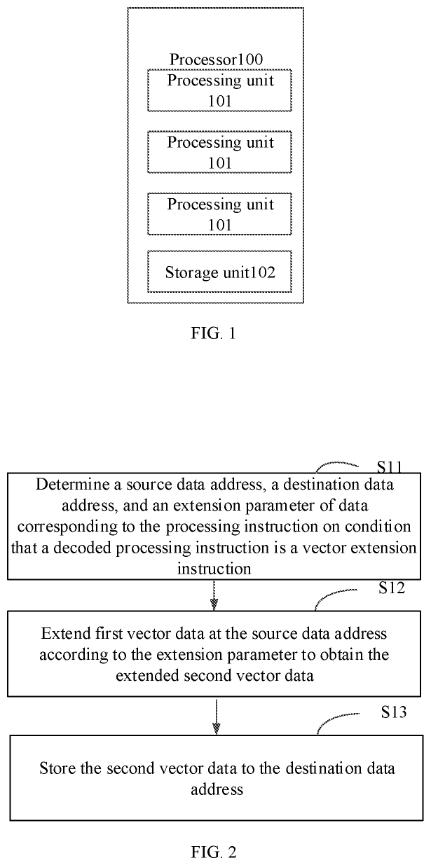

FIG. 1 is a schematic diagram of a processor for a data processing method, according to an embodiment of the present disclosure. As illustrated in FIG. 1, a processor 100 includes multiple processing units 101 and a storage unit 102. The multiple processing units 101 are configured to execute instruction sequences. The storage unit 102 is configured to store data, and the storage unit 102 may include a random access memory (RAM) and a register file. The multiple processing units 101 in the processor 100 may share a portion of the storage space, such as a portion of the RAM storage space and the register file, and may also have their own storage spaces.

FIG. 2 is a flow chart of a method for data processing according to an embodiment of the present disclosure. As illustrated in FIG. 2, the method includes:

In Step S11, determining a source data address, a destination data address, and an extension parameter for data corresponding to the processing instruction on condition that a decoded processing instruction is a vector extension instruction.

In step S12, extending first vector data at the source data address according to the extension parameter to obtain the extended second vector data.

In step S13, storing the second vector data to the destination data address, where the source data address and the destination data address include consecutive data addresses.

According to embodiments of the present disclosure, the extended vector data may be obtained by implementing vector extension and storage according to the extension parameter in the vector extension instruction, thereby simplifying processing and reducing data overhead.

In a possible implementation, the method may further include decoding a received processing instruction to obtain a decoded processing instruction, where the decoded processing instruction includes an operation code, and the operation code is used for indicating a performing of a vector extension processing.

For example, when the processor receives the processing instruction, the processor may decode the received processing instruction to obtain the decoded processing instruction. The decoded processing instruction includes an operation code and an operation field. The operation code is used for indicating a processing type of the processing instruction, and the operation field is used for indicating data to be processed and data parameters. If the operation code of the decoded processing instruction indicates a performing of a vector extension processing, the instruction is the vector extension instruction.

In a possible implementation, if the decoded processing instruction is the vector extension instruction, the source data address, the destination data address, and the extension parameter of the data corresponding to the processing instruction are determined in step S11. The data corresponding to the processing instruction is the first vector data indicated by the operation field of the processing instruction. The first vector data includes multiple data points. The source data address includes present data storage addresses of the multiple data points in a data storage space, which are consecutive data addresses. The destination data address represents data storage addresses for storing multiple data points of the extended second vector data, which are also consecutive data addresses. The data storage space where the source data address is located may be the same as or different from that where the destination data address is located, which is not limited in the present disclosure.

In a possible implementation, after determining the source data address and the extension parameter, in S12, the processor may read the multiple data points of the first vector data from the source data address, and respectively extend the read multiple data points according to the extension parameter, to obtain multiple data points of the extended second vector data, thereby realizing vector extension.

In a possible implementation, the multiple data points of the extended second vector data may be sequentially stored to the destination data address, to obtain the second vector data, thereby completing the vector extension.

Therefore, in scenarios such as image recognition, when vector data needs to be extended, an original vector may be extended to obtain a new vector according to the vector extension instruction, and then the new vector is stored in a consecutive address space, thereby simplifying processing and reducing data overhead.

In a possible implementation, step S11 may include determining a source data address of each of the multiple data points according to a source data base address and a data size of each of the multiple data points of the first vector data in an operation field of the processing instruction.

For example, the vector extension instruction may include the operation field, which is configured to indicate parameters of to be extended vector data. The operation field for example, may include a source data base address, a destination data base address, a single data point size, a single data point number, and an extension parameter.

The source data base address may represent a present base address of the multiple data points of the first vector data in the data storage space. The destination data base address may represent a base address of the multiple data points of the extended second vector data in the data storage space. The single data point size may represent a data size (such as 4 bits or 8 bits) of each data point of the first vector data and a data size of each data point of the second vector data. The single data point number may represent the count N (N is an integer greater than 1) of the data points of the first vector data. The extension parameter may indicate a manner in which the N data points of the first vector data may be extended. There is no restriction on the count of the parameters and a type of each parameter in the operation field of the vector extension instruction in the present disclosure.

In a possible implementation, the operation field of the vector extension instruction may include the source data base address and the single data point size. Since the source data addresses are consecutive data addresses, a source data address of each data point may be directly determined according to the data size of the data point and a serial number of the data point. A source data address of a n^{th} data point may be expressed as:

Single Point Src Addr[n]=Source Data Base Address+n*Single Point Data Size (1).

In formula (1), Single Point Src Addr [n] represents the source data address of the n^{th} data point. When the source data base address is Addr1 [0, 3], and the single data point size is 4 bits, and n equals 3, a source data address of a third data point is Addr1 [12, 15].

In this way, the source data address of each data point may be separately determined, so that each data point of the first vector data may be read from the source data addresses.

In a possible implementation, the first vector data includes N data points, where N is an integer greater than 1. Correspondingly, the extension parameter includes N extension parameter bits corresponding to the N data points. Step S12 may include:

Determining kₙ data points at a n^{th} data position of the second vector data according to a n^{th} data point of the first vector data and a n^{th} extension parameter bit corresponding to the n^{th} data point, where 1≤n≤N, and kₙ≥0; determining the second vector data according to data points of N data positions of the second vector data.

For example, the extension parameter may include N extension parameter bits, which respectively represent the copied times kₙ of the N data points of the first vector data. For example, when N=5, the extension parameter may be expressed as [1, 2, 0, 3, 1], which may indicate that five data points are copied once, twice, zero times, three times, and once, respectively.

In a possible implementation, for the n^{th} data point of the first vector data (1≤n≤N), a n^{th} extension parameter bit corresponding to the n^{th} data point is kₙ (kₙ≥0), and therefore, it may be determined that there are kₙ n^{th} data points of the first vector data at a n^{th} data position of the second vector data. Therefore, respectively extending the N data points of the first vector data may determine the data points at each of the N data positions of the second vector data. For example, the first vector data is [A, B, C, D, E], and the extension parameter may be [1, 2, 0, 3, 1], and then a second vector data [A, B, B, D, D, D, E] is obtained after extension.

It may be understood that the extension parameter may further include other extension contents (for example, enlarging or reducing a value of each data point by specific multiple times). The extension parameter may further include other representations, which may be set by those skilled in the art according to actual situations, and is not limited in the present disclosure.

In this way, the second extended vector data may be obtained.

In a possible implementation, step S13 may include sequentially storing data points of the second vector data according to a destination data base address and a data size of the destination data address.

For example, after the extended second vector data is obtained, the second vector data may be stored to the preset destination data address. The operation field of the vector extension instruction may include the destination data base address. A destination data address of each data point of the second vector data may be determined according to the destination data base address and a single point data size.

Single Point Dest Addr[m]=Destination Data Base Address+m*Single Point Data Size (2).

In formula (2), Single Point Src Addr[m] represents a destination data address of a m^{th} data point of the second vector data (the second vector data includes M data points, and 1≤m≤M, and M is an integer greater than 1). For example, when the destination data base address is Addr2 [14, 17], and the single data point size is 4 bits, and m equals 3, a source data address of a third data point may be determined as Addr2 [26, 29].

In this way, the data points of the second vector data may be sequentially stored to the destination data address, thereby completing the whole process of the vector extension.

According to the data processing method of embodiments of the present disclosure, the vector may be extended according to the vector extension instruction, so that in application scenarios such as image recognition, when vector data needs to be extended, an original vector may be extended to be a new vector, and then the new vector is stored in a consecutive address space, thereby simplifying processing and reducing the data overhead.

It needs to be noted that, for the sake of simplicity, the foregoing method embodiments are described as a series of action combinations, however, those skilled in the art should know that the present disclosure is not limited by the sequence of described actions. According to the present disclosure, certain steps may be performed in other orders or simultaneously. Besides, those skilled in the art should know that the embodiments described in the specification are optional embodiments, and the actions and units involved are not necessarily essential to the present disclosure.

It needs to be further noted that although steps in the flowchart are indicated by arrows and illustrated in sequence, these steps are not necessarily executed in sequence as indicated by the arrows. Unless explicitly stated in the present disclosure, there are no strict restrictions on sequence on the execution of these steps, and these steps may be performed in other sequences. Further, at least a portion of the steps in the flowchart may include multiple sub-steps or multiple stages, These sub-steps or stages are not necessarily executed at the same time, but may be executed at different times, and the execution sequence of these sub-steps or stages is not necessarily sequential, but may be executed in turn or alternately with other steps or sub-steps of other steps or at least a part of stages.

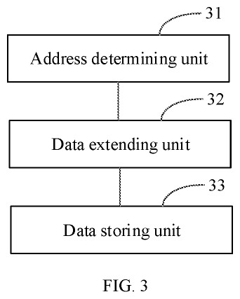

FIG. 3 is a block diagram of an apparatus for data processing according to an embodiment of the present disclosure. As illustrated in FIG. 3, the apparatus includes an address determining unit 31, a data extending unit 32, and a data storing unit 33.

The address determining unit 31 is configured to determine a source data address, a destination data address, and an extension parameter for data corresponding to the processing instruction, on condition that a decoded processing instruction is a vector extension instruction.

The data extending unit 32 is configured to obtain second vector data extended by extending first vector data at the source data address according to the extension parameter.

The data storing unit 33 is configured to store the second vector data to the destination data address, where the source data address and the destination data address include consecutive data addresses.

In a possible implementation, the address determining unit may include a source-address determining sub-unit.

The source-address determining sub-unit is configured to determine a source data address of the multiple data points, according to a source data base address and a data size of multiple data points of the first vector data in an operation field of the processing instruction.

In a possible implementation, the first vector data includes N data points, and the extension parameter includes N extension parameter bits corresponding to the N data points, where N is an integer greater than 1.

The data extending unit includes a data-point determining sub-unit and a data determining sub-unit.

The data-point determining sub-unit is configured to determine kₙ data points at a n^{th} data position of the second vector data according to a n^{th} data point of the first vector data and a n^{th} extension parameter bit corresponding to the n^{th} data point, and 1≤n≤N, and kₙ≥0.

The data determining sub-unit is configured to determine the second vector data according to data points of N data positions of the second vector data.

In a possible implementation, the data storing unit includes a storing sub-unit.

The storing sub-unit is configured to store data points of the second vector data sequentially according to a destination data base address and a data size of the destination data address.

In a possible implementation, the apparatus may further include a decoding unit.

The decoding unit is configured to obtain the decoded processing instruction by decoding a received processing instruction, where the decoded processing instruction includes an operation code, and the operation code is used for indicating a performing of a vector extension processing.

It may be understood that, the apparatus embodiments described above are merely illustrative. The apparatus of the present disclosure may be implemented through other manners. For example, the division of the unit/module is only a logical function division, and there may be other manners of division during actual implementations. For example, multiple units, modules, or components may be combined or may be integrated into another system, or some features may be ignored or not performed.

In addition, unless otherwise specified, the functional units/modules in various embodiments of the present disclosure may be integrated into one unit/module, or the units/modules may be physically alone, or two or more units/modules may be integrated into one unit/module. The above-mentioned integrated unit/module may be implemented in the form of hardware or a software function unit.

If the integrated unit/module is implemented in the form of hardware, the hardware may be a digital circuitry, an analog circuitry, and the like. Physical implementation of the hardware structure includes but is not limited to transistors, memristors, and the like. Unless otherwise specified, the IPU may be any suitable hardware processor such as CPU, GPU, FPGA, DSP, ASIC (application specific integrated circuit), and the like. Unless otherwise specified, the storage unit may be any suitable magnetic storage medium or magneto-optical storage medium, for example, a resistive random access memory (RRAM), a dynamic RAM (DRAM), a static RAM (SRAM), an enhanced DRAM (EDRAM), a high-bandwidth memory (HBM), a hybrid memory cube (HMC), and the like.

The integrated unit/module may be stored in a computer-readable memory when it is implemented in the form of a software functional unit and is sold or used as a separate product. Based on such understanding, the technical solutions of the present disclosure essentially, or the part of the technical solutions that contributes to the related art, or all or part of the technical solutions, may be embodied in the form of a software product, which is stored in a memory and includes multiple instructions for making a computer device (which may be a personal computer, a server, or a network device and the like) to perform all or part of the steps described in the various embodiments of the present disclosure. The memory includes various medium capable of storing program codes, such as a universal serial bus (USB) flash disk, a read-only memory (ROM), a random access memory (RAM), a removable hard disk, a magnetic disk, or an optical disk, and the like.

In a possible implementation, an artificial intelligence chip is provided, which includes the data processing apparatus described above.

In a possible implementation, an electronic device is provided. The electronic device includes the artificial intelligence chip described above.

In a possible implementation, a board card is disclosed. The board card includes a storage component, an interface apparatus, a control component, and the artificial intelligence chip. The artificial intelligence chip is respectively connected with the storage component, the control component, and the interface apparatus. The storage component is configured to store data. The interface apparatus is configured to realize data transmission between the artificial intelligence chip and an external device. The control component is configured to monitor a state of the artificial intelligence chip.

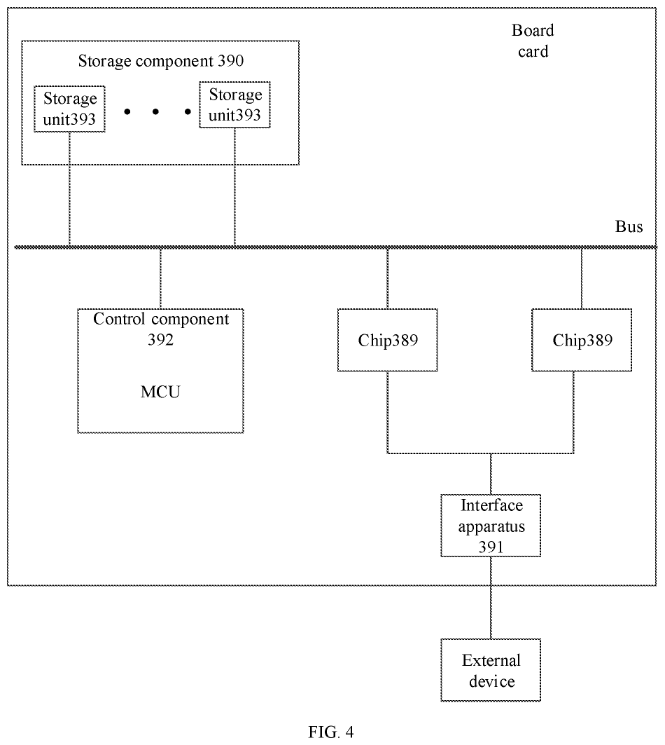

FIG. 4 is a structural block diagram of a board card according to an embodiment of the present disclosure. As illustrated in FIG. 4, in addition to a chip 389, the board card may further include other support components, which include but are not limited to: a storage component 390, an interface apparatus 391, and a control component 392.

The storage component 390 is connected with the artificial intelligence chip via a bus and is configured to store data. The storage component may include multiple groups of storage units 393. Each group of the storage unit is connected with the artificial intelligence chip via the bus. It is understandable that each group of the storage unit may be a double data rate Synchronous Dynamic random access memory (DDR SDRAM).

The DDR may increase a speed of SDRAM by multiple times without increasing a clock frequency, and the DDR allows data to be read at a rising edge and a falling edge of a clock pulse. The speed of DDR is twice as fast as that of standard SDRAM. In an example, the storage apparatus may include four groups of the storage units. Each group of the storage unit may include multiple DDR4 particles (chips). In an embodiment, the artificial intelligence chip may include four 72-bit DDR4 controllers. In the 72-bit DDDR4 controllers, 64-bit is used for data transmission and 8-bit is used for ECC verification. It is understandable that a theoretical bandwidth of data transmission may reach 25600 MB/s when DDR4-3200 particles are used in each group of the storage units.

In an embodiment, each group of the storage units may include multiple DDR SDRAMs which are set in parallel. The DDR may transmit data twice in a clock cycle. A controller for controlling DDR is set in the chip for controlling data transmission and data storage of each storage unit.

The interface apparatus is electrically connected with the artificial intelligence chip. The interface apparatus is configured to realize data transmission between the artificial intelligence chip and an external device (such as a server or a computer). For example, in an embodiment, the interface apparatus may be a standard PCIe (peripheral component interface express) interface. For example, data to be processed is transmitted to the chip by the server through the standard PCIe interface to realize data transmission. In some embodiments, when a PCIe 3.0×16 interface is used for transmission, the theoretical bandwidth may reach 16000 MB/s. In another embodiment, the interface apparatus may be other interfaces, and the present disclosure is not intended to limit specific representations of other interfaces, as long as the interface unit may realize transfer function. In addition, a computation result of the artificial intelligence chip is still transmitted back to the external device (such as the server) by the interface apparatus.

The control component is electrically connected with the artificial intelligence chip. The control component is configured to monitor the state of the artificial intelligence chip. Specifically, the artificial intelligence chip and the control component may be electrically connected through an SPI (serial peripheral interface). The control component may include a micro controller unit (MCU). The artificial intelligence chip may include multiple processing chips, multiple processing cores, or multiple processing circuits, and the artificial intelligence chip may drive multiple loads. Therefore, the artificial intelligence chip may work under different working states such as a multi-load working state and a light-load working state. The control apparatus may be configured to regulate the working states of the multiple processing chips, the multiple processing chips, and/or the multiple processing circuits in the artificial intelligence chip.

In a possible implementation, an electronic device is disclosed, and the electronic device includes the above artificial intelligence chip. The electronic device includes an apparatus for data processing, a robot, a computer, a printer, a scanner, a tablet computer, an intelligent terminal, a mobile phone, a drive recorder, a navigator, a sensor, a webcam, a cloud server, a camera, a video camera, a projector, a watch, an earphone, a mobile storage, a wearable device, a transportation means, a household electrical appliance, and/or a medical device. The transportation means includes an airplane, a ship, and/or a vehicle. The household electrical appliance includes a television, an air conditioner, a microwave oven, a refrigerator, an electric rice cooker, a humidifier, a washing machine, an electric lamp, a gas cooker, and a range hood. The medical device includes a nuclear magnetic resonance spectrometer, a B-ultrasonic scanner, and/or an electrocardiograph.

In the foregoing embodiments, the description of each embodiment has its own emphasis. For the parts that is not described in detail in one embodiment, reference may be made to related descriptions in other embodiments. The technical features of the above-described embodiments may be arbitrarily combined, and all possible combinations of the technical features of the above-described embodiments have not been described to make the description concise. However, as long as there is no contradiction in the combinations of the technical features, they should all be considered as the scope described in this specification.

The foregoing may be better understood according to following clauses.

Article A1, a data processing method, comprising:
determining a source data address, a destination data address, and an extension parameter of data corresponding to a decoded processing instruction, on condition that the decoded processing instruction is a vector extension instruction;
obtaining a second vector data extended by extending a first vector data of the source data address according to the extension parameter; and
storing the second vector data to the destination data address, wherein
the source data address and the destination data address include consecutive data addresses.

Article A2, the method of article A1, wherein determining the source data address, the destination data address, and the extension parameter of the data corresponding to the decoded processing instruction, on condition that the decoded processing instruction is the vector extension instruction, includes:
determining source data addresses of a plurality of data points, according to a source data base address and a data size of the plurality of data points of a first vector data in an operation field of the decoded processing instruction.

Article A3, the method of article A1 or A2, wherein the first vector data includes N data points, and the extension parameter includes N extension parameter bits corresponding to the N data points, wherein N is an integer greater than 1, wherein extending the first vector data of the source data address according to the extension parameter to obtain the extended second vector data includes:
determining kₙ data points at a n^{th} data position of the second vector data according to a n^{th} data point of the first vector data and a n^{th} extension parameter bit corresponding to the n^{th} data point, wherein 1≤n≤N, and kₙ≥0; and determining the second vector data according to data points of N data positions of the second vector data.

Article A4, the method of any one of articles A1 to A3, wherein storing the second vector to the destination data address includes:
sequentially storing data points of the second vector data, according to a destination data base address and a data size of the destination data address.

Article A5, the method of any one of articles A1 to A4, further comprising:
decoding a received processing instruction to obtain the decoded processing instruction, wherein
the decoded processing instruction includes an operation code, and the operation code is used for indicating a performing of a vector extension processing.

Article A6, a data processing apparatus, comprising:
an address determining unit configured to determine a source data address, a destination data address, and an extension parameter of data corresponding to a decoded processing instruction, on condition that the decoded processing instruction is a vector extension instruction;
a data extending unit configured to obtain a second vector data extended by extending a first vector data of the source data address according to the extension parameter; and
a data storing unit configured to store the second vector data to the destination data address, wherein the source data address and the destination data address include consecutive data address.

Article A7, the apparatus of A6, wherein the address determining unit includes:
a source address determining sub-unit configured to determine source data addresses of a plurality of data points according to a source data base address and a data size of the plurality of data points of the first vector data in an operation field of the decoded processing instruction.

Article A8, the apparatus of article A6 or A7, wherein the first vector data includes N data points, and the extension parameter includes N extension parameter bits corresponding to the N data points, wherein N is an integer greater than 1, and the data extending unit includes:
a data point determining sub-unit configured to determine kₙ data points at a n^{th} data position of the second vector data according to a n^{th} data point of the first vector data and a n^{th} extension parameter bit corresponding to the n^{th} data point, wherein 1≤n≤N, and kₙ≥0; and
a data determining sub-unit configured to determine the second vector data according to data points of N data positions of the second vector data.

Article A9, the apparatus of any one of articles A6 to A8, wherein the data storing unit includes:
a storing sub-unit configured to store data points of the second vector data sequentially according to a destination data base address and a data size of the destination data address.

Article A10, the apparatus of any one of articles A6 to A9, further comprising:
a decoding unit configured to obtain the decoded processing instruction by decoding a received processing instruction, wherein
the decoded processing instruction includes an operation code, and the operation code is used for indicating a performing of a vector extension processing.

Article A11, an artificial intelligence chip, wherein the chip includes the apparatus for data processing of any one of articles A6 to A10.

Article A12, an electronic device, wherein the electronic device includes the artificial intelligence chip of article A11.

Article A13, a board card, wherein the board card comprises:
a storage component, an interface apparatus, a control component, and the artificial intelligence chip of claim 11, wherein
the artificial intelligence chip is connected with the storage component, the control component, and the interface apparatus respectively;
the storage component is configured to store data;
the interface apparatus is configured to realize data transmission between the artificial intelligence chip and an external device; and
the control component is configured to monitor a state of the artificial intelligence chip.

The embodiments of the present disclosure are described in detail herein, and specific examples are described herein to illustrate the principles and embodiments of the present disclosure, and the above embodiments are intended to help understand the methods and their core ideas of the present disclosure. According to the idea of the present disclosure, the changes or deformations made by those skilled in the art based on the specific implementations and application scope of the present disclosure belong to the protection scope of the present disclosure. In summary, the contents of the specification should not be construed as a limitation of the present disclosure.

What is claimed:

1. A data processing method, comprising:
determining a source data address, a destination data address, and an extension parameter of data corresponding to a decoded processing instruction, on condition that the decoded processing instruction is a vector extension instruction;
obtaining a second vector data extended by extending a first vector data of the source data address according to the extension parameter; and
storing the second vector data to the destination data address, wherein
the source data address and the destination data address include consecutive data addresses.

2. The method of claim 1, wherein determining the source data address, the destination data address, and the extension parameter of the data corresponding to the decoded processing instruction, on condition that the decoded processing instruction is the vector extension instruction includes:
determining source data addresses of a plurality of data points, according to a source data base address and data sizes of the plurality of data points of a first vector data in an operation field of the decoded processing instruction.

3. The method of claim 1, wherein the first vector data includes N data points, and the extension parameter includes N extension parameter bits corresponding to the N data points, wherein N is an integer greater than 1, wherein extending the first vector data of the source data address according to the extension parameter to obtain the extended second vector data includes:
determining kₙ data points at a n^{th} data position of the second vector data according to a n^{th} data point of the first vector data and a n^{th} extension parameter bit corresponding to the n^{th} data point, wherein 1≤n≤N, and kₙ≥0; and
determining the second vector data according to data points of N data positions of the second vector data.

4. The method of claim 1, wherein storing the second vector data to the destination data address includes:
sequentially storing data points of the second vector data, according to a destination data base address and a data size of the destination data address.

5. The method of claim 1, further comprising:
decoding a received processing instruction to obtain the decoded processing instruction, wherein
the decoded processing instruction includes an operation code, and the operation code is used for indicating a performing of a vector extension processing.

6. A data processing apparatus, comprising:
an address determining unit configured to determine a source data address, a destination data address, and an extension parameter of data corresponding to a decoded processing instruction, on condition that the decoded processing instruction is a vector extension instruction;
a data extending unit configured to obtain a second vector data extended by extending a first vector data of the source data address according to the extension parameter; and
a data storing unit configured to store the second vector data to the destination data address, wherein the source data address and the destination data address include consecutive data addresses.

7. The apparatus of claim 6, wherein the address determining unit includes:
a source address determining sub-unit configured to determine source data addresses of a plurality of data points according to a source data base address and data sizes of the plurality of data points of the first vector data in an operation field of the decoded processing instruction.

8. The apparatus of claim 6, wherein the first vector data includes N data points, and the extension parameter includes N extension parameter bits corresponding to the N data points, wherein N is an integer greater than 1, and the data extending unit includes:
a data point determining sub-unit configured to determine kₙ data points at a n^{th} data position of the second vector data according to a n^{th} data point of the first vector data and a n^{th} extension parameter bit corresponding to the n^{th} data point, wherein 1≤n≤N, and kₙ≥0; and
a data determining sub-unit configured to determine the second vector data according to data points of N data positions of the second vector data.

9. The apparatus of claim 6, wherein the data storing unit includes:
a storing sub-unit configured to store data points of the second vector data sequentially according to a destination data base address and a data size of the destination data address.

10. The apparatus of claim 6, further comprising:
a decoding unit configured to obtain the decoded processing instruction by decoding a received processing instruction, wherein
the decoded processing instruction includes an operation code, and the operation code is used for indicating a performing of a vector extension processing.

11. (canceled)

12. An electronic device, wherein the electronic device includes an artificial intelligence chip, wherein the artificial intelligence chip includes an apparatus for data processing, comprising:
an address determining unit configured to determine a source data address, a destination data address, and an extension parameter of data corresponding to a decoded processing instruction, on condition that the decoded processing instruction is a vector extension instruction;
a data extending unit configured to obtain a second vector data extended by extending a first vector data of the source data address according to the extension parameter; and
a data storing unit configured to store the second vector data to the destination data address, wherein the source data address and the destination data address include consecutive data addresses.

13. (canceled)
